(19) United States
(12) Patent Application Publication
(10) Pub. No.: US 2018/0232705 A1
(43) Pub. Date: Aug. 16, 2018

(54) MEETING TIMELINE MANAGEMENT TOOL

(71) Applicant: Microsoft Technology Licensing, LLC, Redmond, WA (US)

(72) Inventors: Casey James Baker, Seattle, WA (US); Jason Thomas Faulkner, Seattle, WA (US); Jose Alberto Rodriguez, Seattle, WA (US); Shay Gray Harris, Redmond, WA (US)

(73) Assignee: Microsoft Technology Licensing, LLC, Redmond, WA (US)

(21) Appl. No.: 15/433,456

(22) Filed: Feb. 15, 2017

(51) Int. Cl. G06Q 10/10; G06F 3/0481; G06F 3/0482

(52) U.S. Cl. CPC G06Q 10/1095; G06F 3/0482; G06F 3/04817

(57) ABSTRACT

Methods and systems for creating a meeting and adjusting an associated meeting timeline are provided. A meeting administrator may partition the meeting timeline to set specific time periods for discussing certain topics during the meeting. In some cases, the meeting timeline may be adjusted across the meeting lifecycle, e.g., during pre-, live- and post-meeting phases. In some aspects, when the end of a specific time period is approaching during a live meeting, meeting participants may receive a notification that prompts the meeting participants to move to the next meeting topic. In other aspects, if a meeting participant cannot attend a meeting, the meeting participant may employ a bot to attend and record the missed meeting. Meeting highlights may be identified and, during the post-meeting phase, a meeting participant may review the most important aspects of the missed meeting based on priority characteristics assigned to aspects of the meeting.

### BACKGROUND

Collaboration is an essential aspect of nearly every organization, and the ability to run effective and productive meetings is generally critical to the overall success of an organization. Whether virtual or in-person, meetings provide a forum for participants to build supportive relationships with each other and learn about one another's perspectives and ideas. They also afford instant feedback on project progress and performance. Effective time management during meetings leads to productive meeting outcomes. Current meeting time management systems are typically employed manually. For example, a team leader may announce the meeting agenda before the start of the meeting and allocate time to each participant and/or topic. However, attempting to manage a meeting agenda while simultaneously engaging in meeting dialogue is an endeavor that inevitably strays off-topic, diminishing overall meeting productivity and efficiency. Furthermore, managing presentation media while managing a meeting agenda becomes increasingly difficult as more media items are introduced and as the number of meeting participants increases. Meeting participants often experience difficulty in accessing these media items during the meeting, and especially during the post-meeting phase. This lack of accessibility to documents and other media items associated with a meeting can also diminish overall productivity and efficiency in the workplace. Moreover, conflicting meetings may force potential participants to miss important collaboration and media dissemination, potentially delaying or hampering the progress or implementation of a project.

It is with respect to these and other general considerations that example aspects, systems, and methods have been described. Also, although relatively specific problems have been discussed, it should be understood that the examples should not be limited to solving the specific problems identified in the background.

### SUMMARY

Collaboration and project management can be significantly improved with the utilization of an effective meeting timeline management tool that allows topic and participant time allocations to be adjusted during the pre-meeting and/or live meeting phases and allows for automatic notifications during a meeting to signal topic or participant transitions. Such notifications may further deliver media items associated with the next topic or participant. Additionally, such a tool may allow meeting participants to seamlessly upload and download media items associated with the meeting. Lastly, such a meeting timeline management tool may allow meeting participants to review the most important facets of a recorded meeting and associated content according to heuristic sorting and prioritization. The meeting timeline management tool may be integrated with various applications, including but not limited to collaboration products such as Microsoft® Teams, Skype for Business®, and Microsoft Office® products.

In an aspect, a computer system is provided. The computer system includes a processing unit and a memory storing computer executable instructions that, when executed by the processing unit, cause the computer system to receive a request to schedule a meeting, where the meeting is associated with a meeting duration. Based at least in part on the meeting duration, the computer system creates a meeting timeline and partitions the meeting timeline into at least two time periods, where each time period corresponds to a portion of the meeting duration. Additionally, the computer system associates a media item with at least one of the time periods of the meeting timeline.

In another aspect, a method of creating a meeting timeline is provided. The method includes receiving a request to schedule a meeting, where the meeting is associated with a meeting duration. Based at least in part on the meeting duration, the method further includes creating a meeting timeline and receiving at least two topics for discussion at the meeting. Additionally, the method includes automatically partitioning the meeting timeline into at least two time periods corresponding to the at least two topics, where each time period corresponds to a portion of the meeting duration. The method further includes receiving an adjustment to at least a first time period of the at least two time periods and automatically adjusting at least a second time period of the at least two time periods so as to correspond to the meeting duration.

In still another aspect, a computer storage device is provided. The computer storage device stores computer-executable instructions that when executed by a processor perform a method. The method includes receiving a request to schedule a meeting, where the meeting is associated with a meeting duration. Based at least in part on the meeting duration, the method further includes creating a meeting timeline and partitioning the meeting timeline into at least two time periods, where each time period corresponds to a portion of the meeting duration. Additionally, the method includes associating at least one media item with at least one of the at least two time periods of the meeting timeline and prioritizing one or more aspects of the meeting.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 is a flow chart illustrating a method for creating a meeting.

FIG. 2 is a flow chart illustrating a method for joining a meeting.

FIG. 3A illustrates an example of an application before the pre-meeting setup process begins.

FIG. 3B illustrates an example of an application during the pre-meeting joining process.

FIG. 4A illustrates an example of an application during the pre-meeting setup process.

FIG. 4B illustrates an example of an application during the pre-meeting timeline adjustment process featuring the allocation of discussion time to certain topics.

FIG. 4C illustrates an example of an application during the pre-meeting timeline adjustment process featuring the uploading of multiple media items and allocation of time to each media item.

FIG. 5A illustrates an example of an application during the live meeting stage.

FIG. 5B illustrates an example of an application during the live meeting stage featuring a timeline preview of uploaded media content.

FIG. 6A illustrates an example of an application during the live meeting stage featuring a soft notification.

FIG. 6B illustrates an example of an application during the live meeting stage featuring a notification alert.

FIG. 7 illustrates an example of an application during the post-meeting stage featuring playback functionality.

FIG. 8 illustrates an example of an application during the post-meeting stage featuring a custom search.

FIG. 9 is a flow chart illustrating a method for receiving, processing, and storing meeting input data and using that data to generate appropriate results.

FIG. 10 is a block diagram illustrating example physical components of a computing device with which aspects of the disclosure may be practiced.

FIGS. 11A and 11B are simplified block diagrams of a mobile computing device with which aspects of the present disclosure may be practiced.

FIG. 12 is a simplified block diagram of a distributed computing system in which aspects of the present disclosure may be practiced.

FIG. 13 illustrates a tablet computing device for executing one or more aspects of the present disclosure.

### DETAILED DESCRIPTION

In the following detailed description, references are made to the accompanying drawings that form a part hereof, and in which are shown by way of illustrations or specific examples. These aspects may be combined, other aspects may be utilized, and structural changes may be made without departing from the present disclosure. Example aspects may be practiced as methods, systems, or devices. Accordingly, example aspects may take the form of a hardware implementation, a software implementation, or an implementation combining software and hardware aspects. The following detailed description is therefore not to be taken in a limiting sense, and the scope of the present disclosure is defined by the appended claims and their equivalents.

As discussed above, effective time management during meetings leads to productive meeting outcomes. Current meeting time management systems are typically employed manually. For example, a team leader may announce the meeting agenda before the start of the meeting and allocate an amount of speaking time to one or more meeting participants. Maintaining or adjusting these time increments generally happens extemporaneously, often times through vocal ques delivered by the meeting leader. However, a meeting participant may have a difficult time estimating when his or her time allocation begins and ends. The same difficulty occurs when the meeting agenda is partitioned according to meeting topics. Multiple meeting participants may be engaged in conversation about a certain topic and become unaware of the time. Attempting to manage a meeting agenda while simultaneously engaging in meeting dialogue is an endeavor that inevitably strays off-topic, diminishing overall meeting productivity and efficiency.

Furthermore, managing presentation media while managing a meeting timeline becomes increasingly difficult as more media items are introduced and as the number of meeting participants increases. For instance, meeting participants often experience difficulty in acquiring and/or retrieving these media items at appropriate times during the meeting, and particularly during the post-meeting phase. For example, media items may be presented in a particular order during the meeting, e.g., a PowerPoint® may be presented during which various documents or other media items related to a project may be discussed, different media items may be presented by different presenters, and the like. In some cases, meeting participants may not have access to the media items on their individual devices; in other cases, meeting participants may receive the various media items in a package or haphazardly before or during the meeting. It would be useful for participants to receive such materials when they become relevant during the meeting. Moreover, it would be useful for meeting participants to have access to such materials prior to or after a meeting within the context, or meeting timeline, to which they apply. Not only so, it would be useful for potential participants who are unable to join the meeting to have access to the meeting timeline, including recorded discussions and media items, in a prioritized ordering.

The meeting timeline management tool increases productivity, at least, by (1) more efficiently managing meeting timelines and (2) improving team-member interactions. The systems and methods disclosed herein may be utilized to increase the quality of both meeting timeline management and team-member interactions across the entire meeting lifecycle: pre, live, ongoing, and post engagement. Today, there is no current capability to manage meeting timelines and associated media across the entire meeting lifecycle. In one example aspect, a team-member may act as a meeting administrator and setup a meeting during the pre-meeting phase of the meeting lifecycle. During the pre-meeting setup process, the meeting administrator may invite other team-members to the meeting and set the meeting timeline. Setting the meeting timeline may entail partitioning the meeting timeline into certain meeting segments. For example, the meeting administrator may partition the meeting timeline according to a combination of factors, including but not limited to the number of participants, the identity of the participants, the nature of the meeting, the agenda of meeting topics, the relative importance of the meeting topics, etc.

During the live meeting phase of the meeting lifecycle, some example aspects may allow a meeting administrator to adjust the meeting timeline allocation. For example, if a meeting participant is speaking on an important subject that unforeseeably requires more speaking time, then the meeting administrator may adjust the meeting timeline accordingly in real-time. In other example aspects, a meeting participant may upload a media item, such as a text document or slide deck, to any point along the meeting timeline. Other meeting participants may then have the opportunity to view or download the media item during the live meeting phase, as well as the post-meeting phase.

After the live meeting has concluded, in some example aspects, users (whether attendees of the meeting or not) may review the meeting by accessing certain segments of the meeting timeline according to specified criteria. For example, a user may review any portion of a previous meeting, e.g., a time period associated with a discussion of a certain topic. In some cases, the user may have permissions for accessing the meeting timeline and all associated media content and/or recordings. In other cases, a user may submit a request to the meeting timeline manager to receive appropriate media content and/or recordings. Similarly, in other examples, a user may not want to review the associated media and recorded meeting in its entirety. Instead, based on accessing the meeting timeline, a user may opt to review certain segments of the recorded meeting according to specified criteria, such as meeting topic, identity of the speaker, associated media and various meeting dynamics. Additionally, in other example aspects, a team-member who may desire to attend different, but time-conflicting meetings, may command an automatic bot or bots to record and participate in a missed meeting. It is with respect to these and other general considerations that example aspects have been made.

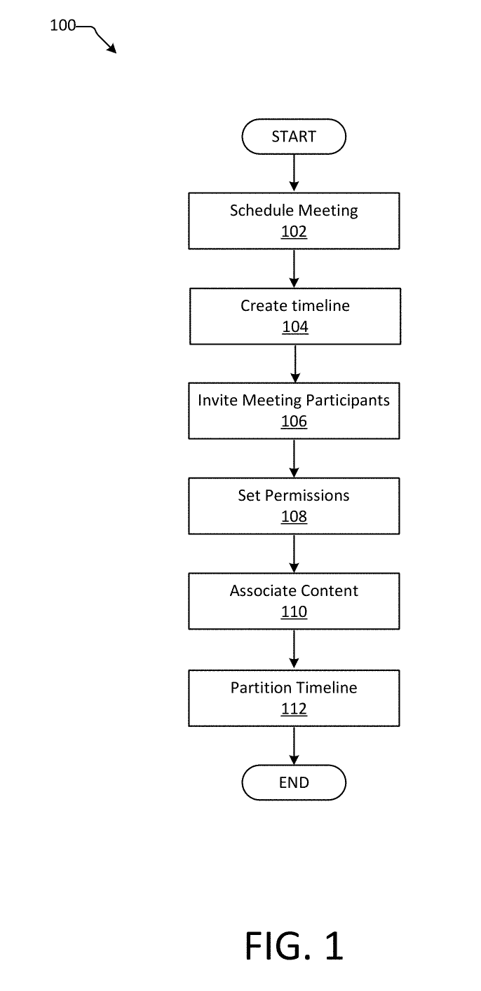

FIG. 1 is a flow chart illustrating a method for creating a meeting. Method 100 begins with a schedule meeting operation 102. A team-member may act as a meeting administrator to schedule a meeting. Scheduling the meeting may entail establishing standard logistics, such as the title (or topic) of the meeting; date; start time, end time and/or duration; location; conference call information and/or video links; etc.

At create meeting timeline operation 104, a meeting timeline may be created. The meeting timeline may include one or more time segments (or periods). The meeting timeline may be associated with and/or encompassed within a global timeline. The global timeline may be associated with an individual user, a workgroup, a department, a social network, and the like.

At invite meeting participants operation 106, the meeting administrator may invite one or more participants to join the meeting. In some cases, the meeting may be configured to be forwarded by invited participants to additional attendees. Alternatively, the meeting administrator may post the meeting for attendee registration.

At set permissions operation 108, the meeting administrator may adjust meeting permissions with regard to meeting timeline allocation adjustment and recordings. For example, a meeting administrator may restrict the ability to adjust the meeting timeline to participants who are deemed additional administrators. In other examples, a meeting administrator may allow any meeting participant to adjust the meeting timeline during various phases of the meeting lifecycle. In other example aspects, a meeting administrator may permit a subset of the meeting participants to record the meeting and prohibit another subset of the meeting participants from recording the meeting. Other permissions associated with the meeting, such as ability to upload and download media items, may be set at this time. As should be appreciated, any permission may be granted to any user (whether an attendee or otherwise) as the meeting administrator deems appropriate.

At associate content operation 110, the meeting administrator may pre-stack media items onto the meeting timeline. By pre-stacking media items onto the meeting timeline, the meeting administrator may avoid having to locate and share a media item during a live meeting because the media item will already be integrated into the meeting timeline and be available to the meeting participants at the scheduled time assigned to the media item. In one example aspect, the meeting administrator may upload a presentation slide deck onto the meeting timeline during the pre-meeting phase. In other examples, pre-stacking media items may be performed by a non-administrator team-member who may be presenting at an upcoming meeting. In at least some aspects, when a meeting timeline is adjusted prior to or during a meeting, an availability of any media item associated with an adjusted time period may be adjusted correspondingly.

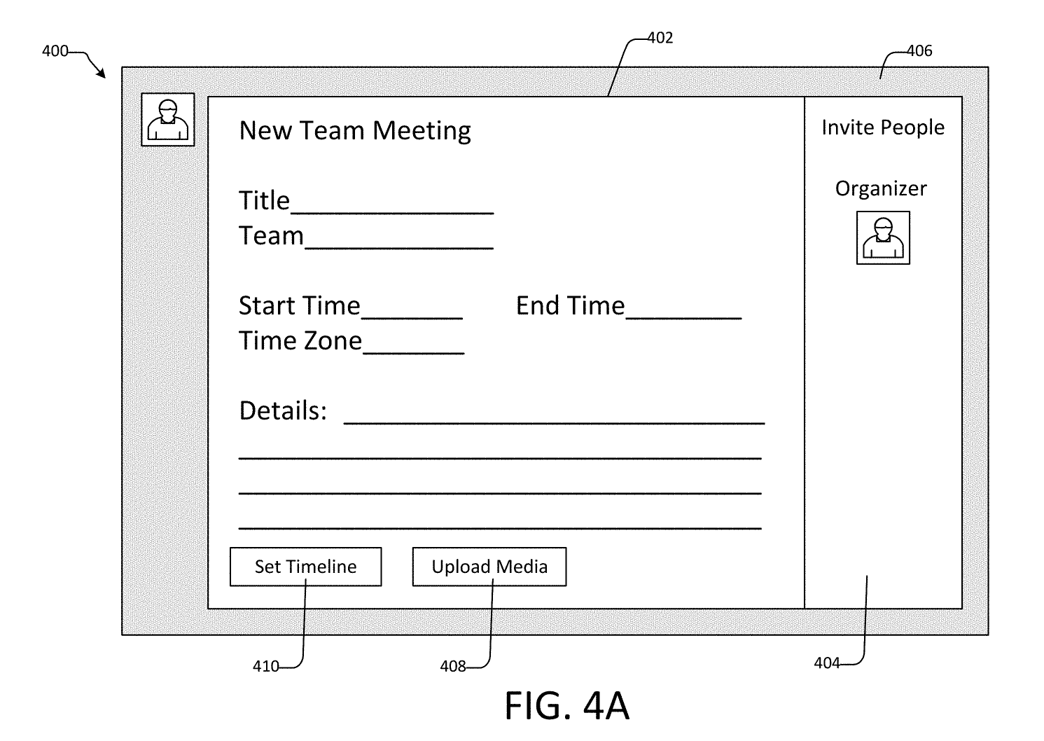

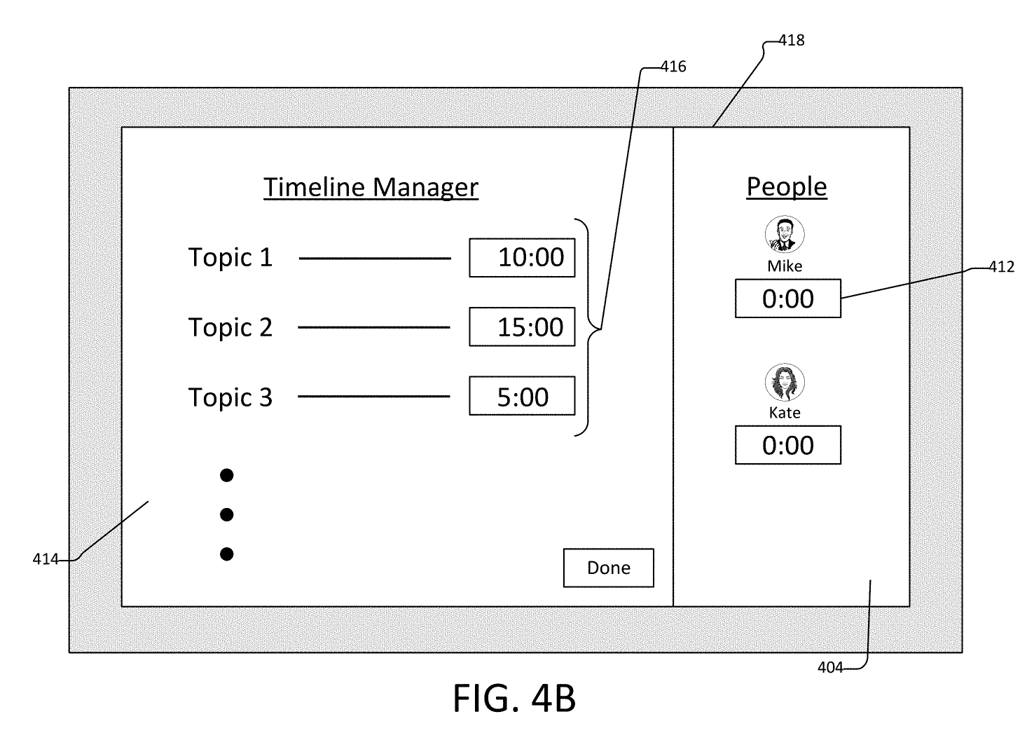

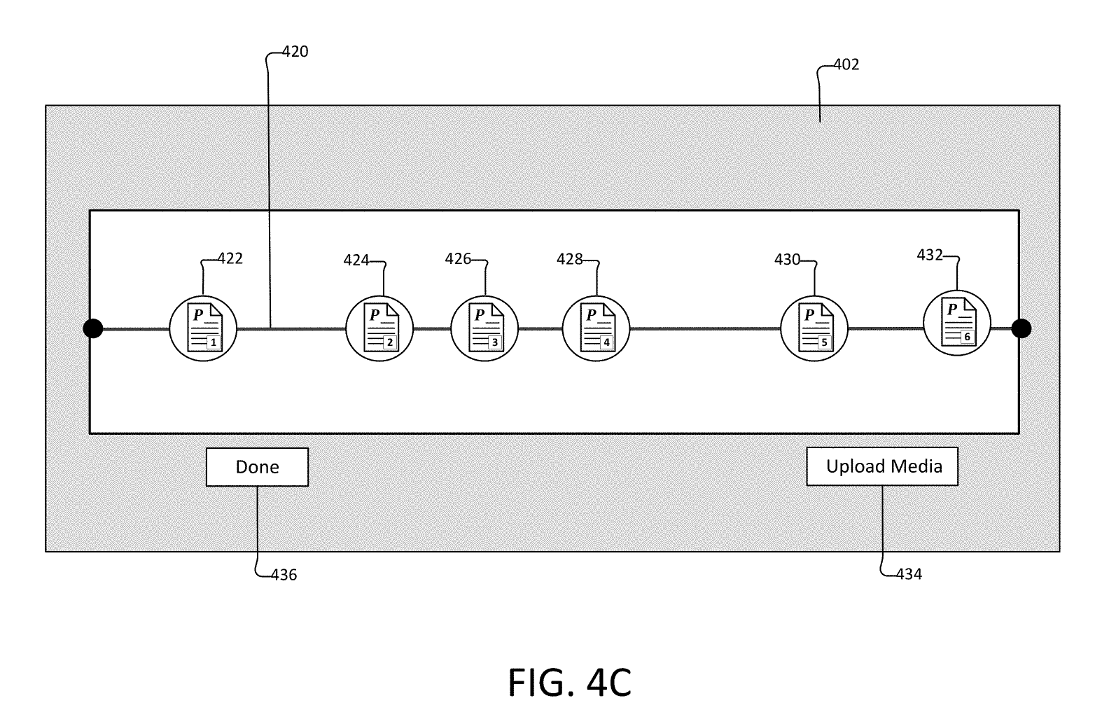

At partition timeline operation 112, the meeting administrator may partition the meeting timeline according to a variety of characteristics, including the number of meeting participants, the identity of the meeting participants, meeting topics, etc. For example, if a meeting administrator invited five participants at invite meeting participants operation 106, the meeting administrator may allocate equal speaking time to each of the five meeting participants. In another example aspect, the meeting administrator may want to associate various media items with different partitions of the meeting timeline. For instance, the meeting administrator may partition the slides of a presentation on the meeting timeline, where each slide is associated with a designated start time and a designated finish time (see FIG. 4C). By leveraging this pre-meeting phase, a meeting administrator who may be presenting at an upcoming meeting may avoid the task of presentation time management because the meeting timeline manager is managing the timing of the slides from the presentation. Alternatively, different media items (e.g., a slide deck, a document, a spreadsheet, etc.) may be pre-stacked for the meeting such that each media item becomes available at a pre-selected time during the meeting. In further aspects, a meeting administrator may allow one or more meeting participants to upload media items and associate such media items with appropriate time periods within the meeting timeline.

In other example aspects, operations 102-112 may be performed in any order. For example, the associate content operation 110 may come before the invite participants operation 106. Similarly, the set permissions operation 108 may happen after the partition timeline operation 112.

As should be appreciated, the various devices, components, etc., described with respect to FIG. 1 are not intended to limit system 100 to being performed by the particular components described. Accordingly, additional topology configurations may be used to practice the methods and systems herein and/or components described may be excluded without departing from the methods and systems disclosed herein.

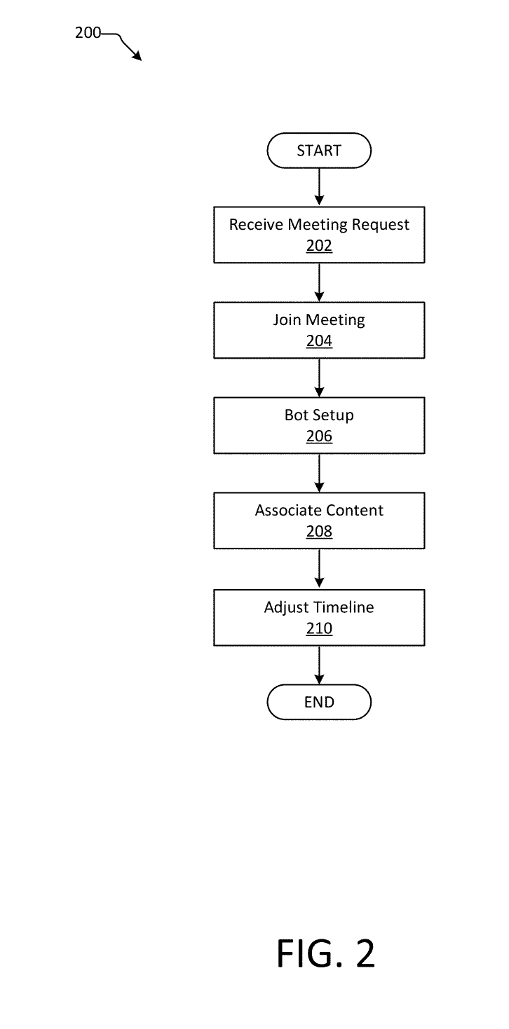

FIG. 2 is a flow chart illustrating a method for joining a meeting. Method 200 begins with receive meeting request operation 202, where a user (potential meeting participant) may receive a meeting request from a meeting creator or a meeting administrator.

At join meeting operation 204, the user may elect to join or not join the meeting. Alternatively, rather than receiving a meeting request, the meeting may be posted to a global timeline or group forum and a user may elect to join the meeting (e.g., by registration or otherwise).

At bot setup operation 206, a bot may be configured. For instance, a user may be unable to attend a meeting but may program a bot to attend the meeting in his or her place. A “bot,” also known as a web robot, is a software application that runs automated tasks or scripts over a network. In some cases, the bot may be programmed to provide content and/or present questions within the meeting. In other aspects, a bot may be programmed to manage the meeting, i.e., present a slide deck based on a pre-determined meeting timeline, record questions and discussions, utilize voice recognition to make updates to documents discussed during the meeting, and the like. Further, the bot may record a meeting that a user is unable to attend. The recording may then be processed and classified according to a variety of priority characteristics, such as the importance of the meeting topic, the identity of the speakers, the duration of speaking time for each meeting participant, and biometric data. Thus, when the user reviews the missed meeting, the user may easily identify the most important and relevant aspects of the meeting from the bot. Instead of reviewing the past meeting in its entirety, the team-member may now have the ability to review the relevant aspects of the meeting in a fraction of the time, thereby improving overall work productivity and efficiency.

At associate content operation 208, similar to associate content operation 110, a user (whether intending to join the meeting or not) may elect to upload a media item or items to the meeting timeline at any phase of the meeting lifecycle—i.e., before, during or after the meeting. In some cases, such user may have been granted permissions by the meeting administrator (or meeting manager bot) to upload content to the meeting timeline. In other cases, the user may have no such permissions and may be unable to upload content to the meeting timeline.

At adjust timeline operation 210, a user may adjust the meeting timeline according to the permissions that have been granted to the user. In some aspects, the user may be permitted to upload content to the meeting timeline, but may be prohibited from adjusting the meeting timeline. In such a scenario, the user may still be permitted to adjust the media item within the allocated time slot on the meeting timeline. For example, the user may be allocated 20 minutes of speaking time in an upcoming meeting and may elect to upload a presentation slide deck to the meeting timeline. The user may then be permitted to partition the individual slides of the presentation within the allocated 20-minute timeframe of the meeting timeline. In other example aspects, a user (non-administrator) may be permitted to adjust the meeting timeline. For example, a user (e.g., a project manager who did not create the meeting) may feel that a certain topic deserves more time than is currently allocated on the meeting timeline or may determine that additional or different topics should be covered. The user may adjust the meeting timeline accordingly, either prior to or during the meeting. In other aspects, a user may be granted permissions for both uploading content to the meeting timeline and adjusting the meeting timeline. Alternatively, the user may not be permitted to upload content to the meeting timeline or adjust the meeting timeline.

In other example aspects, the method operations 202, 204, 206, 208, and 210 may be performed out of order or may not be performed at all. For example, a user who received an invitation to join a meeting may adjust the meeting timeline in operation 210 before setting up a bot in operation 206. Similarly, a user may upload a media item or items in operation 208 before setting up a bot in operation 206.

As should be appreciated, the various devices, components, etc., described with respect to FIG. 2 are not intended to limit system 200 to being performed by the particular components described. Accordingly, additional topology configurations may be used to practice the methods and systems herein and/or components described may be excluded without departing from the methods and systems disclosed herein.

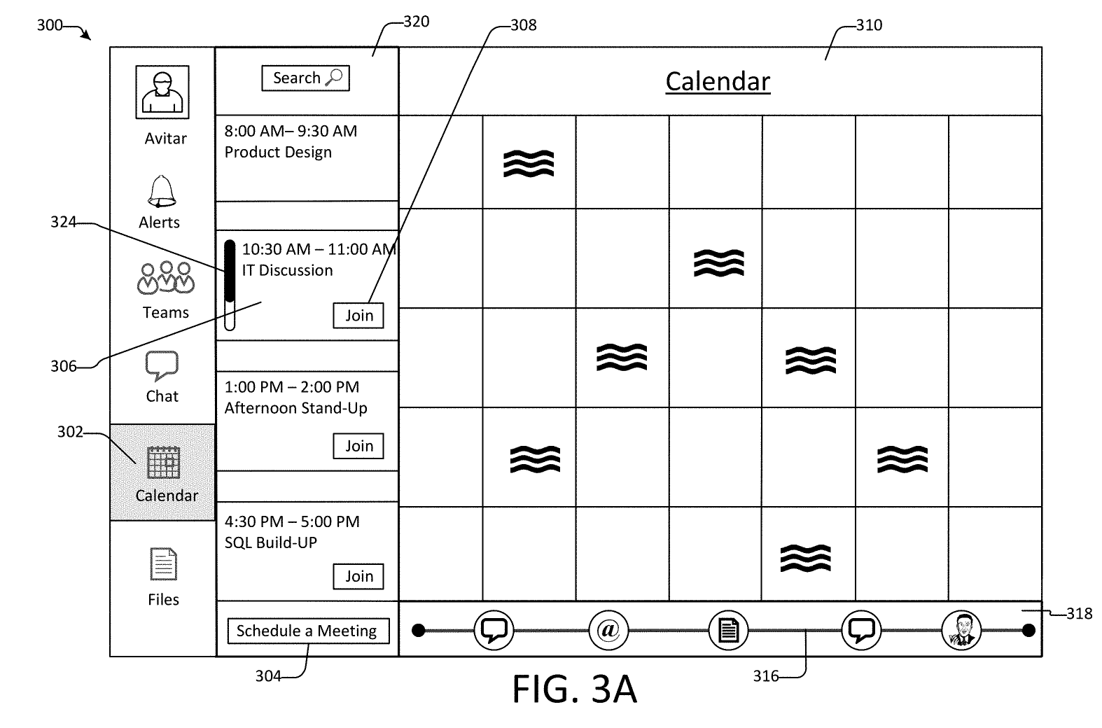

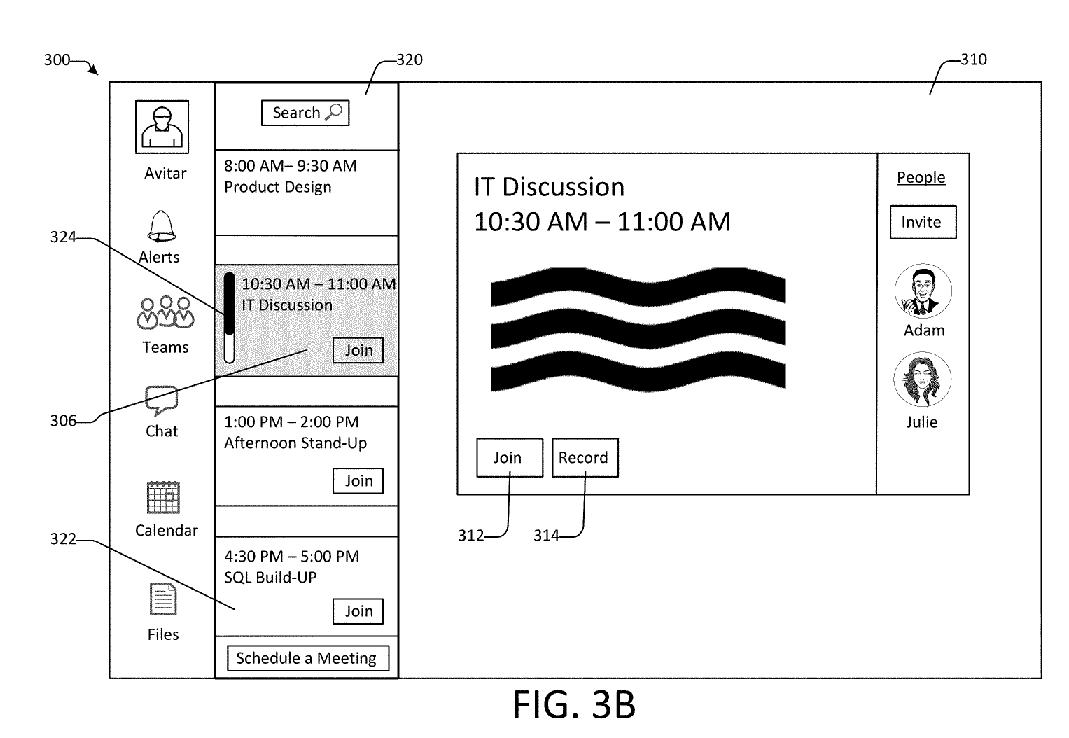

FIG. 3A illustrates an example of an application before the pre-meeting setup process begins. The application illustrated in FIG. 3A may represent a variety of web applications, including but not limited to Microsoft® Teams, Skype for Business®, and Microsoft Office® products. In order to initiate the pre-meeting setup phase, a user may select the calendar icon 302, e.g., located on the left side of interface 300. Upon selecting the calendar icon 302, the interface 300 may display one or more panes such as a list pane 320 that displays upcoming events and meetings and/or indicates which meetings are in progress. For example, an in-progress meeting 306 is denoted by a thin progress bar 324 on the left side of the rectangular area. If a user had yet to join the in-progress meeting 306, the user may have the option of joining the in-progress meeting 306 by selecting the join button 308. Additionally, upon selecting the calendar icon 302, the interface 300 may display an enlarged calendar in content pane 310 that may be adjusted to reflect a daily, weekly, monthly, or annual view. In some example aspects, a user may select schedule a meeting button 304 to create a future meeting (see FIG. 4A) and invite at least one meeting participant (see FIG. 4B).

In at least some aspects, a user's calendar may further be reflected as a global timeline 316 in a time pane 318 of user interface 300. The global timeline 316 may be interactive such that the user may easily slide back and forth along the global timeline 316, e.g., by swiping, forward/back controls, etc. In this way, a user may easily view past, current and/or future events such as meetings, appointments, media items (e.g., recordings, documents, videos, spreadsheets, presentations, etc.), tasks, etc. As should be appreciated, different events may be identified by different icons along global timeline 316. For instance, a meeting event may be identified by one icon and a media item such as a document may be identified by another icon. In some cases, upon hovering over an event icon, additional information such as a title for the event may be displayed. Further, a meeting associated with additional content (e.g., media items) may be identified by a different icon than a meeting that is not associated with additional content. A user may select events along the global timeline 316 (e.g., by clicking or hovering over an event icon) and, in response to the selection, additional information regarding a selected event may be displayed, e.g., in content pane 310, in a popup window, or otherwise. For instance, upon selecting a meeting, a meeting timeline (not shown) within the global timeline 316 may be displayed. In aspects, once selected, the user may adjust the meeting timeline, may upload media items to the meeting timeline, etc. In further aspects, displaying the meeting timeline may enable access to any associated content, e.g., media items such as presentations, documents, spreadsheets, audio or video recordings, etc.

FIG. 3B illustrates an example of an application during a join meeting process. Upon selecting the in-progress meeting 306, the in-progress meeting 306 may be identified as selected in list pane 320, e.g., by shading, to indicate that the information now displayed in the content pane 310 is associated with the in-progress meeting 306. The in-progress meeting 306 is denoted by a thin progress bar 324 on the left side of the rectangular area that may indicate how much time is remaining in the in-progress meeting 306. The information displayed in content pane 310 may provide a join button 312 for joining the meeting and/or a record button 314 for requesting a recording of the meeting. In some aspects, record button 314 may alternatively assign a bot to record the in-progress meeting 306 for review at a later time. In some aspects, e.g., when the record button 314 is selected after the in-progress meeting 306 has started, the bot may retrieve a full recording of the meeting, e.g., by communicating with other bots that recorded the missed portion of the in-progress meeting 306 or otherwise. In some cases, a meeting may have been configured for recording and the bot may request access to the missed segment and meeting input data of the in-progress meeting 306.

In other example aspects, a user may join a meeting that is not in progress, e.g., meeting 322. In this case, if the user cannot attend the meeting 322, the user may elect to record meeting 322 by clicking a record button, e.g., similar to record button 314, prior to the commencement of the meeting. Whether the user joined in-progress meeting 306 or meeting 322, the user may retrieve a recording of the meeting, processed meeting input data, and any media items that may have been shared with the meeting participants during the meeting. In at least some aspects, such information may be prioritized so that the user may easily review the most important and/or relevant aspects of the meeting without reviewing the entire recording of the meeting.

As should be appreciated, the various methods, devices, components, etc., described with respect to FIG. 3A and FIG. 3B are not intended to limit interface 300 to being performed by the particular components described. Accordingly, additional topology configurations may be used to practice the methods and systems herein and/or components described may be excluded without departing from the methods and systems disclosed herein.

FIG. 4A illustrates an example of an application interface 400 during a pre-meeting setup process. After a user has elected to schedule (or create) a meeting (see FIG. 3A), the user may become a meeting administrator by default. As meeting administrator, the user may be responsible for entitling the meeting, establishing a start time and an end time, providing any necessary meeting details, etc. After electing to schedule a meeting, a meeting setup screen 402 may appear. In some aspects, background 406 may be dimmed. The user may enter the pertinent information and invite one or more other users to be meeting participants in area 404. In at least some aspects, the meeting setup screen 402 may include one or more dropdown menus, up/down controls, partially populated fields, etc., for facilitating entry of meeting details (not shown). The user (e.g., meeting administrator) may also select a set timeline button 410 to create and/or adjust a meeting timeline and/or select an upload media button 408 to upload a media item or items to the meeting timeline. Additionally, the meeting administrator may set permissions on the meeting, e.g., recording permissions, media upload/download permissions, meeting timeline permissions, etc. For example, a meeting administrator may grant full administrator privileges to one or more meeting participants (e.g., media upload privileges, meeting timeline privileges, etc.). In other examples, the meeting administrator may elect to grant partial administrator privileges to one or more meeting participants (e.g., media upload privileges but not meeting timeline privileges). In still other examples, the meeting administrator may not grant any administrator privileges to other meeting participants. In another example aspect, a meeting administrator may limit the number of media items that may be uploaded to the meeting timeline by other meeting participants. For example, the meeting administrator may allow each meeting participant to upload one media item to the meeting timeline. As should be appreciated, the meeting administrator may have broad capabilities to grant or restrict permissions for any other meeting participant. Alternatively, some meeting participants may have default administrator permissions (e.g., based on job title) whether or not such participant scheduled the meeting. For instance, a project manager may have default administrator permissions to a meeting scheduled by a project team member.

FIG. 4B illustrates an example of an application during the pre-meeting timeline adjustment process featuring the allocation of discussion time to certain topics. After selecting the set timeline button 410, the meeting administrator may then adjust the meeting timeline within a timeline manager interface 418. In aspects, the meeting timeline may be automatically populated with a meeting duration (total meeting time) based on the start and end times input during meeting setup. The meeting administrator may then define an amount of time within the meeting duration that each of the meeting participants may speak by selecting meeting participants in area 404. As illustrated, the meeting administrator may select one of the meeting participants and adjust the amount of time that is allocated to that meeting participant by adjusting a time field, e.g., field 412. The allocation of time may be indicated by minutes and seconds or by a percentage of the overall meeting duration. In FIG. 4B, the meeting timeline allocation is based on meeting topics and not meeting participants, as illustrated by selected time allocations in fields 416 of area 414. In other example aspects, the meeting timeline allocation may be based on meeting participants or on a combination of both meeting topics and meeting participants. For instance, upon selecting a topic (e.g., topic 1) and assigning 10 minutes to the topic, one or more participants may be selected (e.g., Mike and Kate each assigned 5 minutes of the 10 minute period). Alternatively, upon selecting a participant (e.g., Mike) and assigning 10 minutes of speaking time, one or more topics may be selected (e.g., topics 1 and 2). In this case, the meeting administrator and/or the selected participant may hold permissions to assign a time allocation to each topic. As should be appreciated, a meeting administrator may configure the meeting timeline according to any suitable allotment or ordering of time segments.

As illustrated, the meeting administrator has set the meeting timeline according to meeting topic, as indicated by area 414. That is, the meeting administrator selected or input several meeting topics (e.g., topics 1-3 et seq.) and assigned times to each of those topics (e.g., ten minutes for topic 1, fifteen minutes for topic 2, five minutes for topic 3, etc.). The times that are assigned to each topic may be indicated by minutes and seconds or by a percentage of the overall meeting duration.

In some example aspects, adjusting the time allocations for each meeting participant may occur on an interactive timeline (similar to FIG. 4C). Similarly, adjusting the time allocations for each meeting topic may occur on an interactive timeline (similar to FIG. 4C). The interactive timeline feature may include sliding functionality that allows the meeting administrator to click and drag a starting point and an ending point associated with each meeting participant or each meeting topic to define the subsets of time on the meeting timeline (e.g., thereby populating field 412 and/or fields 416). Further aspects may include a function that prevents the overlapping of time allocated to meeting participants and/or meeting topics. For example, if a meeting administrator is utilizing the interactive sliding timeline feature to define the start and end times for meeting topics, the meeting timeline management tool may prevent the meeting administrator from selecting a start time for a second meeting topic prior to an end time of a first meeting topic.

In some example aspects, a meeting administrator may not need to manually adjust the meeting timeline during the pre-meeting phase. For example, if a team consistently has weekly meetings, the meeting timeline management tool may utilize historic meeting data to automatically partition the meeting timeline. If one meeting participant consistently speaks for 30 minutes at each weekly meeting, then the meeting timeline management tool may automatically assign a 30-minute time allocation to that meeting participant. In other example aspects, the meeting timeline management tool may automatically partition the timeline according to importance of topics and projects. If a first subset of team members are working on a more important project than a second subset of team members, then the time that is allocated to the meeting participants of the first subset may be greater than that of the second subset. Likewise, the meeting timeline management tool may partition the meeting timeline according to topic. The meeting timeline may be automatically generated, allocating more time to more important projects or topics than less important projects or topics.

The automatic nature of the meeting timeline management tool may be utilized across all aspects of the meeting lifecycle. For example, if during a live meeting, one of the meeting participants unexpectedly had to leave the meeting. In response to detecting that the participant left the meeting, the meeting timeline may be automatically adjusted to account for that meeting participant's absence. If the now-absent meeting participant was previously assigned a time slot on the meeting timeline, the meeting timeline may be adjusted to delete the absent meeting participant and equally distribute the remaining time among the other meeting participants. The meeting timeline management tool may also automatically distribute the remaining time according to the identity of the speaker or the importance of the remaining meeting topics.

Although the meeting timeline management tool may automatically adjust the meeting timeline, the meeting administrator or administrators may override the automatic meeting timeline allocation. Additionally, the meeting administrator or administrators may have the option to disable the automatic meeting timeline allocation function during both the pre-meeting setup phase and during the live meeting phase.

FIG. 4C illustrates an example of an application during the pre-meeting timeline adjustment process featuring the uploading of multiple media items and allocation of time to each media item. Upon selecting the upload media button 408 from FIG. 4A, meeting timeline 420 may appear over the meeting setup screen 402. In aspects, the meeting setup screen 402 may be dimmed (e.g., grayed out) for the purposes of emphasizing the meeting timeline 420. In aspects, meeting timeline 420 may be an interactive timeline. In some example aspects, the meeting administrator may not set time slot restrictions on meeting timeline 420. This may be beneficial in cases where the meeting administrator is preparing to deliver a presentation during the majority of the meeting. In other example aspects, a presenter may be limited to a subset of time within the overall meeting timeline.

In one example aspect, a meeting administrator may click on the upload media button 434 and upload a presentation file to the meeting timeline. After uploading the presentation file, the meeting administrator may then allocate time to the various slides of the presentation (e.g., slides 422-432) across the meeting timeline 420. For example, slide 428 may receive more allotted time than slide 426 because slide 428 may command more importance during the presentation. In some example aspects, the slides 422-432 may be adjusted on the meeting timeline 420 via clicking and dragging functions.

During the live meeting, a meeting administrator may have the ability to adjust the slides 422-432. In some example aspects, the meeting administrator may not need to manually adjust the slide timing. Instead, the meeting timeline management tool may utilize meeting input data during the presentation to automatically allocate more or less time to certain slides in real time during the meeting presentation. Once the meeting administrator has finished uploading a media item or media items to the meeting timeline 420 and/or set the meeting timeline 420, the meeting administrator may select the done button 436. Upon selecting the done button 436, the meeting timeline 420 may disappear, and the meeting setup screen 402 may reappear, displaying the meeting setup parameters from FIG. 4A.

As should be appreciated, the various methods, devices, components, etc., described with respect to FIG. 4A, FIG. 4B, and FIG. 4C are not intended to limit interface 400 to being performed by the particular components described. Accordingly, additional topology configurations may be used to practice the methods and systems herein and/or components described may be excluded without departing from the methods and systems disclosed herein.

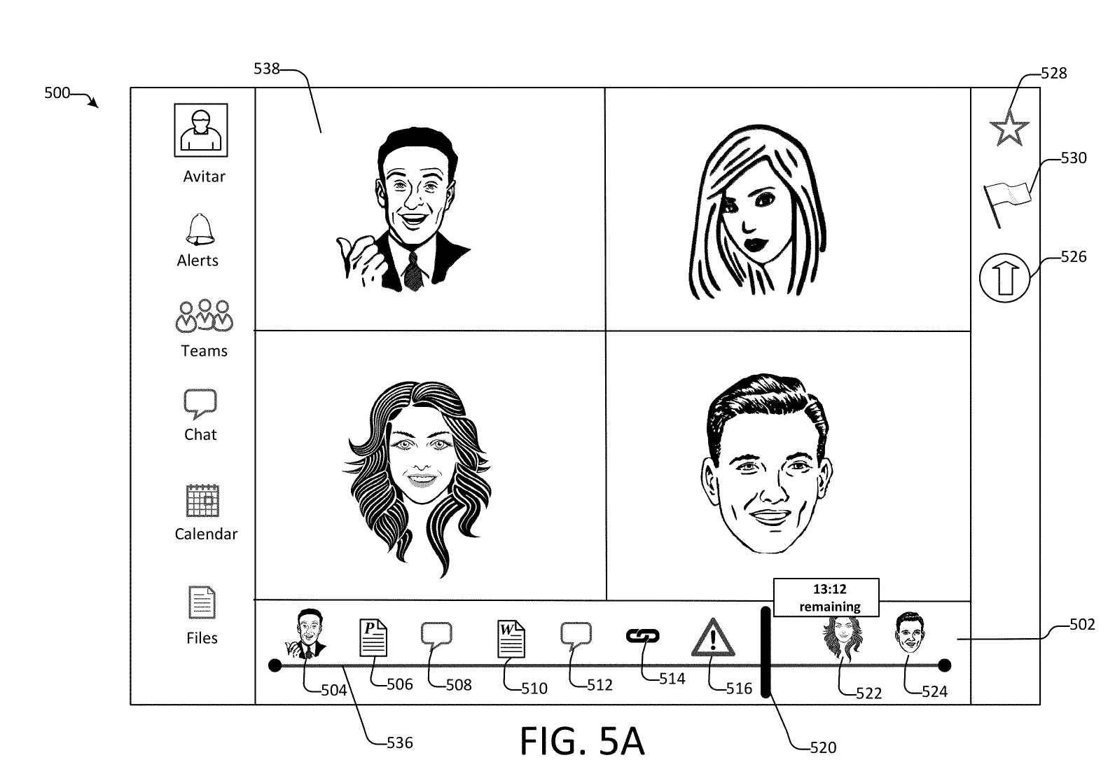

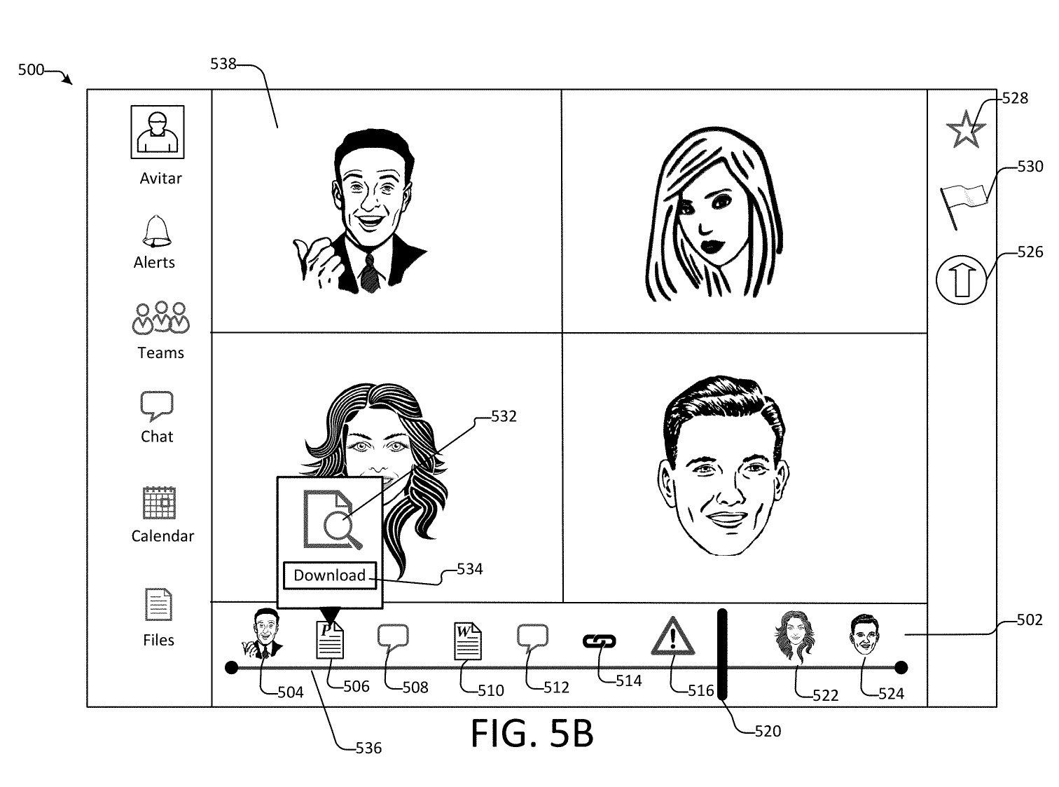

FIG. 5A illustrates an example of an application interface 500 during a live meeting phase. During the live meeting phase, a meeting timeline 536 may be displayed within a time pane 502 of the interface 500. A meeting participant may have the ability to adjust time allocations for various topics and/or participants along meeting timeline 536 if the meeting participant possesses the proper permissions, e.g., default permissions or permissions granted by a meeting administrator. In the illustrated example, the point in time during the meeting displayed within content pane 538 is indicated by progress bar 520. As illustrated, there are 13 minutes and 12 seconds remaining in the meeting. According to icons displayed along the meeting timeline 536, meeting participant 504 spoke first. A presentation 506 was then introduced. A meeting participant then entered a comment 508. Document 510 was then introduced to the meeting. Another meeting participant entered a comment 512. A hyperlink 514 was then introduced, and finally an important event 516 occurred. As should be appreciated, upon selecting any of the displayed icons, a participant may view associated content. That is, at any point after the content is associated with the meeting timeline, e.g., prior to, during or after the meeting, such content may be selected and viewed.

In some example aspects, the presentation 506, the document 510, and the hyperlink 514 may have been previously uploaded in the pre-meeting phase. In this case, a meeting participant may prepare for the meeting by accessing the meeting timeline and selecting one or more of the icons associated with the uploaded content. In other examples, one or more meeting participants may upload content during the live meeting phase, e.g., the presentation 506, the document 510, hyperlink 514, etc. In some aspects, in addition to viewing content associated with meeting timeline 536, users with the proper permissions may download associated media content to one or more personal electronic devices, e.g., by selecting an icon for the content and initiating a download function.

As illustrated, meeting participant 522 and meeting participant 524 are slated to speak next according to the meeting timeline 536. In one example, if meeting participant 504 concluded speaking before the start time slated for meeting participant 522, meeting participant 522 may begin speaking and the meeting timeline 536 may be adjusted accordingly. The meeting timeline 536 may be adjusted manually by a meeting participant, or as previously described, the meeting timeline 536 may be automatically adjusted based on changes occurring during the meeting (e.g., a meeting participant dropping off the call or finishing a speaking slot earlier or later than scheduled), or based on a characteristic, such as the identity of the speaker or the importance of the meeting topic. In some aspects, when a meeting participant runs over an allotted time slot, a notification may be provided to one or more attendees of the meeting, e.g., to the speaker only, to the meeting administrator and the speaker, or to all attendees.

During the live meeting phase, a meeting participant may insert a comment into meeting timeline 536 that may be seen by other meeting participants or may be visible only to a subset of meeting participants. In some cases, the comment may be received via a text input (e.g., into a live chat session associated with the meeting); in other cases, the comment may be received verbally. When the comment is received verbally, an audio recording of the comment, a text transcription of the comment, or both, may be inserted within the meeting timeline 536. Additionally, a meeting participant may have the ability to insert a favorite icon 528 and/or a flag icon 530 at certain points during the live meeting. The favorite icon 528 may represent a point during the meeting that a meeting participant particularly enjoyed or a point during the meeting that was of particular importance. The flag icon 530 may represent a point during the meeting that a meeting participant would like to review at a later time or a point during the meeting that was of particular importance. In some cases, the favorite icon 528 and/or the flag icon 530 may be visible on a user's private instance of the meeting timeline 536. In other cases, the favorite icon 528 and/or the flag icon 530 may be visible to other users. In this case, the favorite icon 528 and/or the flag icon 530 may further identify a user who inserted such indicators.

Additionally, during the live meeting phase, a meeting participant may have the ability to upload a media item by selecting the upload icon 526. After selecting the upload icon 526, a meeting participant may introduce a media item, including but not limited to a document, a presentation file, a spreadsheet, an image file, a video file, an audio file, an executable file, a hyperlink, a compressed file, and the like.

FIG. 5B illustrates an example of an application during the live meeting stage featuring a timeline preview of uploaded media content. During a live meeting, a meeting participant may click on an icon associated with presentation 506, which may trigger a timeline preview 532. A download button 534 may appear on the timeline preview. A meeting participant may then click this download button 534 to download the media item.

As should be appreciated, the various methods, devices, components, etc., described with respect to FIG. 5A and FIG. 5B are not intended to limit interface 500 to being performed by the particular components described. Accordingly, additional topology configurations may be used to practice the methods and systems herein and/or components described may be excluded without departing from the methods and systems disclosed herein.

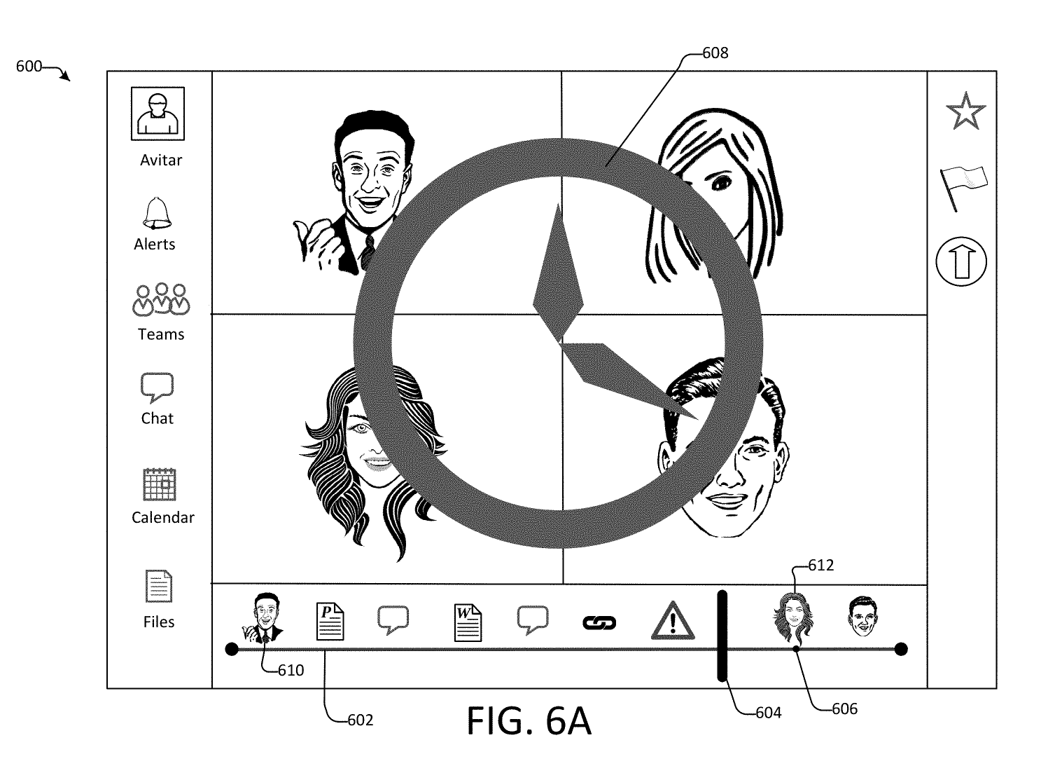

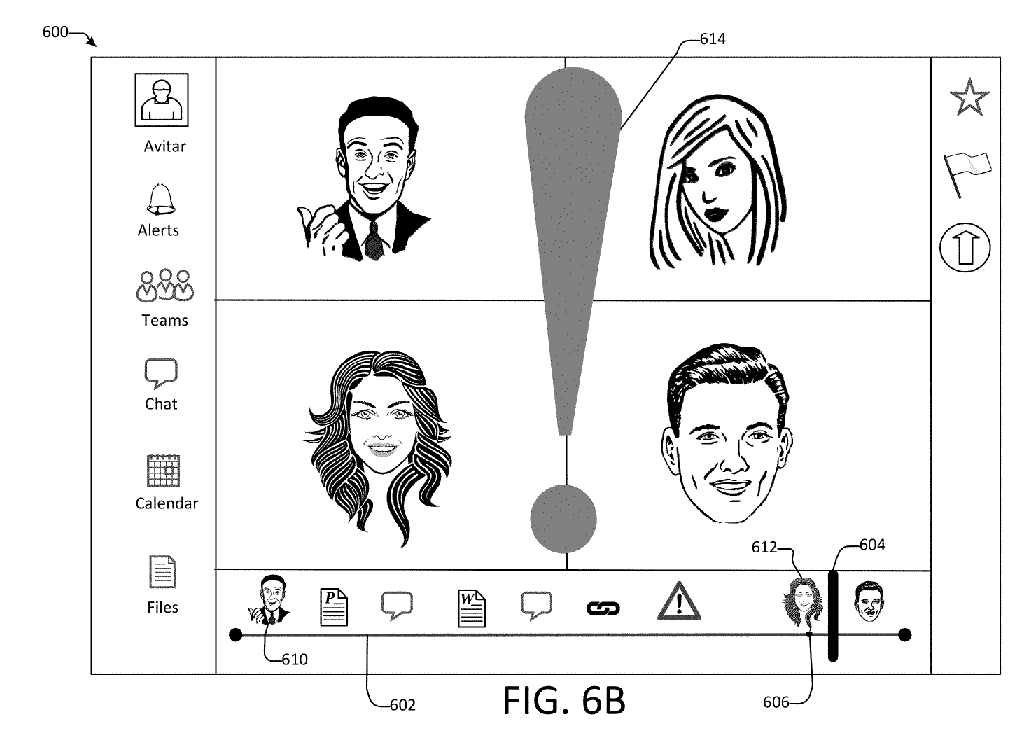

FIG. 6A illustrates an example of an application interface 600 during the live meeting stage featuring a soft notification. Notifications may begin to appear during a live meeting when the meeting participant who is speaking begins to exceed the allotted time period specified on the meeting timeline 602 (e.g., similar to meeting timeline 536 described above). When the meeting participant begins to approach the designated end time of the allotted time period, a soft notification 608 may begin to appear. Soft notification 608 may be represented visually by an opaque clock that begins to gradually appear on the screen, alerting the meeting participant that the allotted time period is approaching its end. Alternatively, the soft notification may be any suitable soft notification, e.g., a textual notification (e.g., “You have five minutes left”), an audio notification (e.g., chime, beep, buzz, etc.), a tactile notification (e.g., vibration of a presentation clicker, etc.), and the like. As illustrated, a current time during the meeting is represented by progress bar 604, and an ending time of the allotted time period for the first speaker (e.g., speaker 610) is represented by time point 606 along the meeting timeline 602 (e.g., when speaker 612 is slated to speak). A soft notification, like soft notification 608, may not be intended to disrupt the meeting flow of the meeting. In some example aspects, the soft notification 608 is a private notification that only the meeting participant can view on his/her personal electronic device. In other aspects, the soft notification 608 may be visible to all meeting participants.

FIG. 6B illustrates another example of an application interface 600 during the live meeting stage featuring a notification alert. Once the meeting participant (e.g., speaker 610) exceeds an allotted time period for speaking or presenting (e.g., exceeding time point 606 as illustrated by progress bar 604), the meeting timeline management tool may initiate a notification alert. The notification alert may be a visual alert represented by notification alert 614. In some aspects, a notification alert may include a combination of different types of notifications, e.g., a visual alert paired with an audio alert, or a visual alert paired with a tactile alert, etc. In some aspects, notification alert 614 may be visible to all participants of the meeting. This feature is especially helpful when meeting participants are engaged in dialogue regarding the presented topic, the notification alert 614 signaling that the participants should move on to the next topic or that the meeting timeline 602 should be adjusted accordingly to allow adequate time for discussing the current topic. Alternatively, notification alert 614 may be provided only to the meeting administrator and the speaker.

In further example aspects, a meeting administrator may have the ability to disable all notifications, disable only soft notifications, disable only notifications alerts, or a combination of the aforementioned throughout the entire meeting lifecycle.

As should be appreciated, the various methods devices, components, etc., described with respect to FIG. 6A and FIG. 6B are not intended to limit interface 600 to being performed by the particular components described. Accordingly, additional topology configurations may be used to practice the methods and systems herein and/or components described may be excluded without departing from the methods and systems disclosed herein.

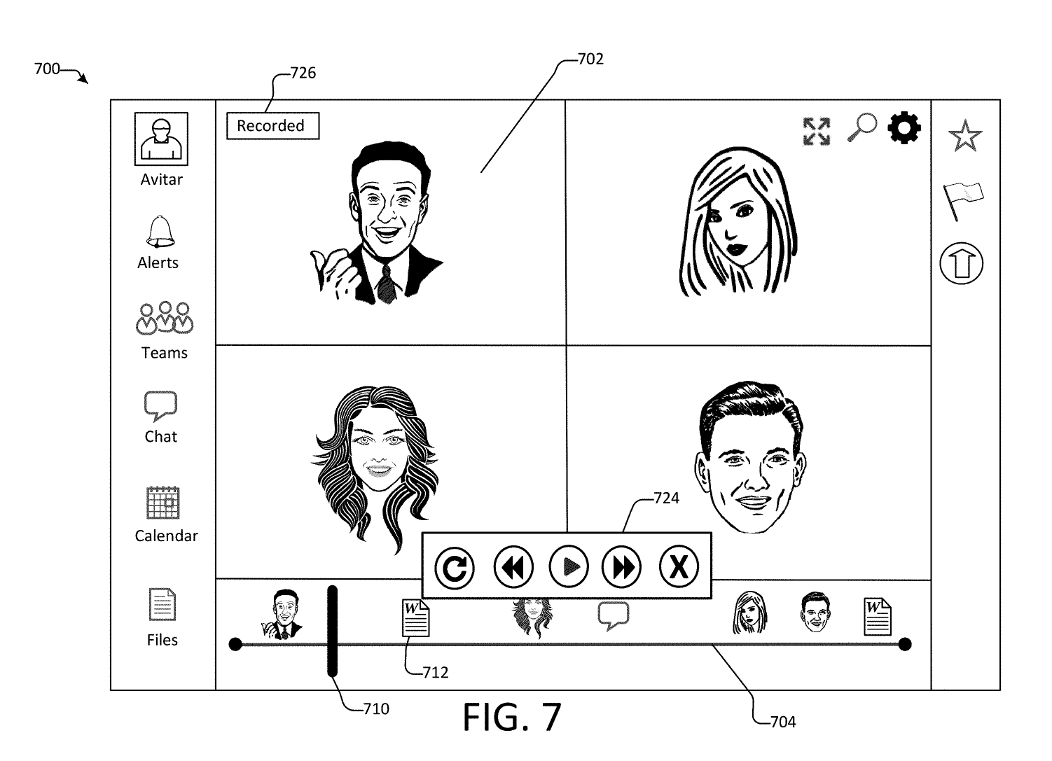

FIG. 7 illustrates an example of an application interface 700 during the post-meeting phase featuring playback functionality. During the post-meeting phase, a user (whether an attendee of the meeting or not) may have the ability to review the entire recorded meeting. As described above, a user may be granted permissions for accessing a recorded meeting. As illustrated in content pane 702, the displayed meeting was previously recorded according to the recorded notification 726. Furthermore, a user may have playback control as indicated by the playback control bar 724. A meeting timeline 704 may allow the user to click and drag progress bar 710 along the meeting timeline 704 to view and/or listen to certain segments of the recorded meeting. In some example aspects, the user may have the ability to click on any of the media items associated with the meeting and view them and/or download them to one or more personal electronic devices. For example, a user may be able to click on an icon associated with a document, e.g., document 712, to launch the document in a word processing application. Alternatively, upon selecting the icon associated with document 712, the user may view a timeline preview of the document and then select the download button (as illustrated in FIG. 5B) to download the document to a personal device.

As should be appreciated, the various methods, devices, components, etc., described with respect to FIG. 7 are not intended to limit interface 700 to being performed by the particular components described. Accordingly, additional topology configurations may be used to practice the methods and systems herein and/or components described may be excluded without departing from the methods and systems disclosed herein.

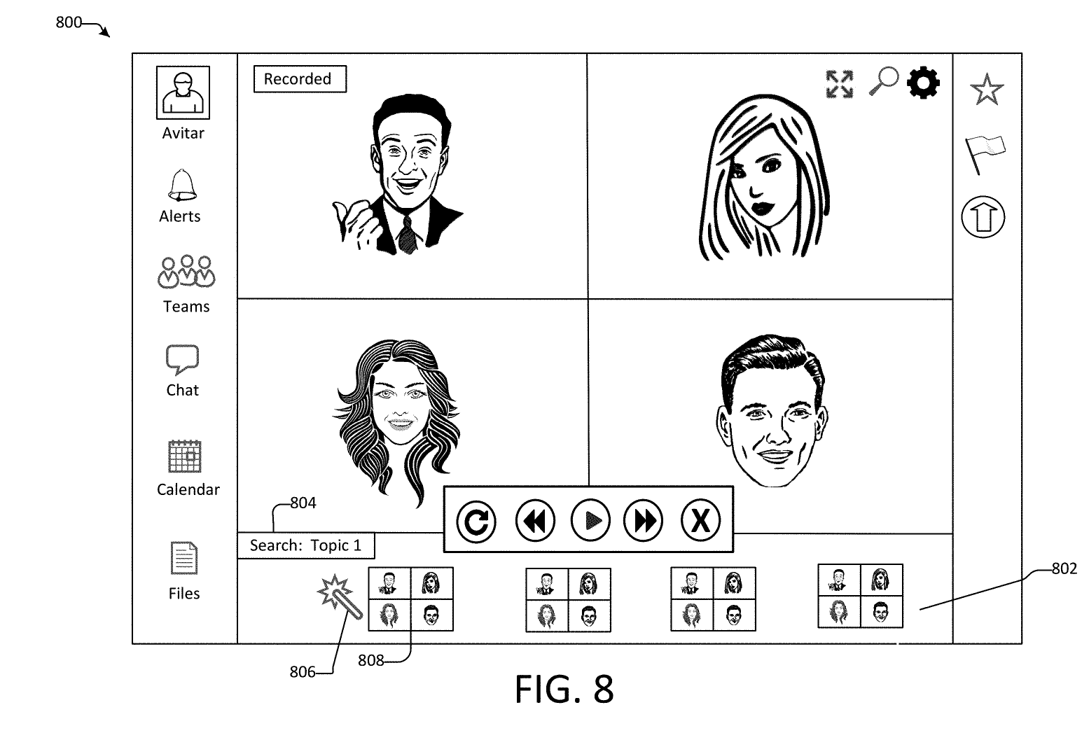

FIG. 8 illustrates another example of an application interface 800 during the post-meeting stage featuring a custom search. During the post-meeting phase, a user (whether an attendee of the meeting or not) may desire to view and/or listen to only the most important and relevant parts of a recorded meeting. The meeting timeline management tool may receive meeting input data (e.g., flag icons, favorite icons, inserted comments, etc.) and/or other metrics (e.g., speaker, topic, etc.) during the live meeting phase. Thereafter, meeting timeline management tool may process that meeting input data and/or other metrics and prioritize aspects of the meeting (e.g., recordings of particular speakers or topics, particular uploaded documents, particular inserted comments, etc.) according to specified heuristics, such as biometric data (e.g., volume of voices, amount of movement among the participants, etc.), the identity of the speaker (e.g., a manager versus a team member is speaking), speaking duration for a speaker, introduction of presentation documents, discussion duration regarding uploaded content, etc. In further example aspects, a meeting participant may initiate a custom search for certain aspects of the recorded meeting. For example, a meeting participant may search for any instances discussing a certain topic. The meeting timeline management tool may receive a search request 804 and produce appropriate results in the results pane 802. The search results may return full recordings of meetings and/or partial recordings of meetings, which may each be identified by a meeting icon (e.g., meeting icon 808). In aspects, upon hovering over a meeting icon, additional information regarding the meeting may be displayed (e.g., “7-18 Budget Meeting” or “Mike Beal's budget forecast, 7-20 Status Meeting”). In further aspects, the search results may be arranged according to importance, chronology, or other priority characteristics. After the search results are displayed in the results pane 802, a meeting participant can then select a result, such as meeting icon 808 and view the associated meeting timeline, uploaded content, inserted comments, audio and/or video recordings, etc., for a full meeting or a segment of a meeting. In some aspects, meeting icon 808 may be associated with a highlight icon 806. Highlight icon 806 may indicate that a processed version of the meeting associated with meeting icon 808 is available. That is, based on the various heuristics described above, aspects of the meeting, e.g., meeting recordings, uploaded content, inserted comments, etc., may be prioritized such that the user may easily identify and view the most important aspects of the meeting.

As should be appreciated, the various methods, devices, components, etc., described with respect to FIG. 8 are not intended to limit interface 800 to being performed by the particular components described. Accordingly, additional topology configurations may be used to practice the methods and systems herein and/or components described may be excluded without departing from the methods and systems disclosed herein.

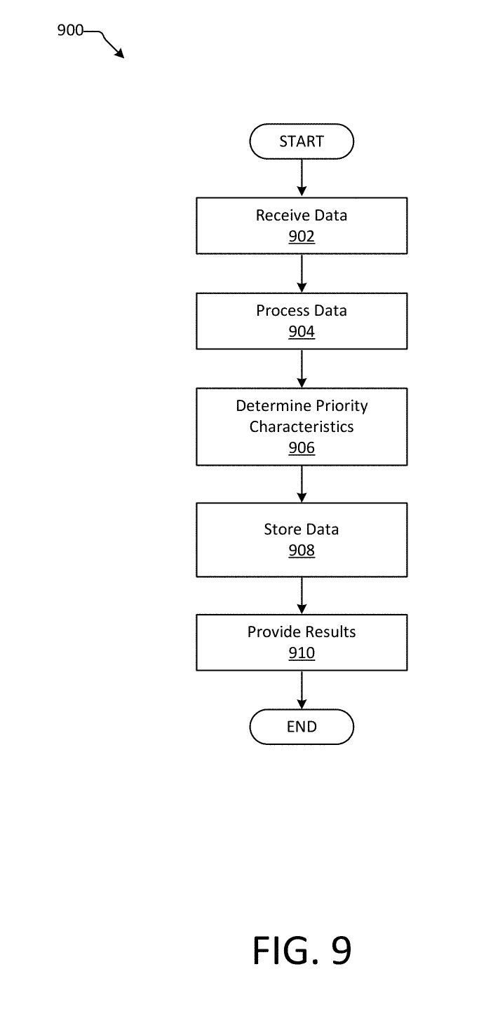

FIG. 9 is a flow chart illustrating a method 900 for receiving, processing, and storing meeting data and using that data to generate appropriate meeting timeline partitions and search results. Method 900 begins with a receive meeting data operation 902, where the meeting data may be automatically gathered via a personal mobile device, a personal computer (laptop or desktop), a shared electronic device like a conference call device, an online public profile, or other electronic device that receive or store such data. In some cases, meeting data may be retrieved from data input by a user when scheduling the meeting, e.g., meeting title, meeting duration, speakers, topics, participants, meeting partition durations, etc.

At process data operation 904, the data may be converted from raw data to machine-readable data. In some example aspects, the machine-readable data may be stored in a local database, remote database, or a combination of both. For example, if the local storage capabilities of an electronic device are low, then a small portion of the machine-readable data may be stored on the device, and a larger portion may be stored on a remote storage location, such as a cloud server. The efficient storage and retrieval of large amounts of data ensures productive conversations and meetings using the method 900.

The raw data may be converted into machine-readable data using a natural language understanding process (e.g., speech recognition). Generally, the central processing unit (“CPU”) of the electronic device is equipped with a specific set of instructions as to how the raw input data should be analyzed. For example, a set of raw data may be processed to remove outliers, instrument reading errors, and other data entry errors. In another example of processing raw data into machine-readable data, a raw image (e.g., video frame captured during a meeting) may be analyzed for particular facial expressions. Based on such processing, human emotions may be detected from the frame that indicate, among other things, agreement, disagreement, confusion, distraction, engagement, etc., among meeting participants represented in the frame. Such information may allow information to be gleaned about the meeting, e.g., a high level of engagement between participants may indicate an important topic whereas a low level of engagement and/or a high level of distraction may indicate a less important topic or a topic relevant only to a subset of the participants. As should be appreciated, many such inferences may be drawn from such processed data.

At determine priority characteristics operation 906, the data may then be compared to previously stored meeting data. The comparison aspect of the determine priority characteristics operation 906 may calculate the most appropriate timeline allocation during a pre-meeting phase or may render the most appropriate search results during a post-meeting phase. For example, previous meetings that allocated a certain amount of time to a topic may be considered when determining the priority characteristics of the current meeting data. If a certain topic has consistently dominated past meetings, then the meeting timeline management tool may place a higher priority on those segments of the meeting that refer to that certain topic.

In an example aspect to determine the priority characteristics operation 906, the determination of which priority characteristics to assign to certain segments of a meeting may be formulated with the assistance of artificial emotional intelligence (“AEI”) algorithms. In one example, a series of different meeting dynamics with corresponding priority characteristics may be pre-programmed. If, during a live meeting, the meeting participants begin to experience similar dynamics to those that have been pre-programmed in the AEI algorithm, the algorithm may employ case-based reasoning to compare the two meetings (the current live meeting with the historical data meeting) and assign similar priority characteristics to a certain segment of the live meeting that were previously assigned to a segment of the pre-programmed meeting. In another example, the AEI algorithm may identify which set of categories or sub-populations a new segment of a meeting (e.g., raw meeting input data) belongs. Such categories and/or sub-populations may include home vs. work, friends vs. work colleagues, one-on-one meetings vs. group meetings, educational lectures vs. recreational settings, etc. Similarly, the AEI algorithms may employ cluster analysis to group sets of meeting objects in such a way that objects in the same group (a cluster) are more similar to each other than to those in other groups (clusters). In one example, clusters may be created according to the identity of the meeting participants. In another example, clusters may be created according to certain meeting topics. These clusters may be used by the AEI algorithms to help determine the most appropriate priority characteristics to assign to certain segments of the meeting.

At the store data operation 908, the meeting data (e.g., raw and/or processed data) and determined priority characteristics may be stored on a local storage medium, a remote storage medium or a combination of both. In example aspects, the store data operation 908 may occur in part and may occur at any stage in the method.

At provide results operation 910, results may be provided automatically, e.g., based on a determination of likely meeting partitioning for a default meeting timeline, or based on a search, e.g., in response to a custom search query in a post-meeting phase, or for creating a prioritized summary of a meeting. In some example aspects, the results generated at provide results operation 910 may comprise generating a default meeting timeline partitioning. For example, certain meeting participants may consistently speak for certain durations of time. Based on this data, past meetings, and segments of meetings, a default meeting timeline may be generated according to historic data regarding the duration of time each meeting participant consumes during a meeting. In another example aspect, the results generated at provide results operation 910 may comprise generating search results according to a user query. For example, a user may enter a search query for a certain topic within a group of meetings associated with a certain team. Based on the analysis of those meetings associated with the certain team, segments of meetings that are associated with the queried topic may be extracted and provided to the user as a search result or results. In another example, a user may enter a search query for a certain meeting participant. Based on the analysis of past meetings, segments of meetings or full meetings associated with the queried meeting participant may be extracted and provided to the user as a search result or results. In yet other example aspects, the results generated at provide results operation 910 may comprise generating a summary of a meeting or group of meetings. Based on the analysis of a single meeting or group of meetings, a summary meeting may be created. A summary meeting may be shorter in duration than a full meeting and comprise the most important segments of a meeting or a group of meetings. The importance of meeting segments may be determined according to a prioritization algorithm, based on the various heuristics described above, aspects of the meeting, e.g., meeting recordings, uploaded content, inserted comments, etc.

As should be appreciated, the various methods, devices, components, etc., described with respect to FIG. 9 are not intended to limit method 900 to being performed by the particular components described. Accordingly, additional topology configurations may be used to practice the methods and systems herein and/or components described may be excluded without departing from the methods and systems disclosed herein.

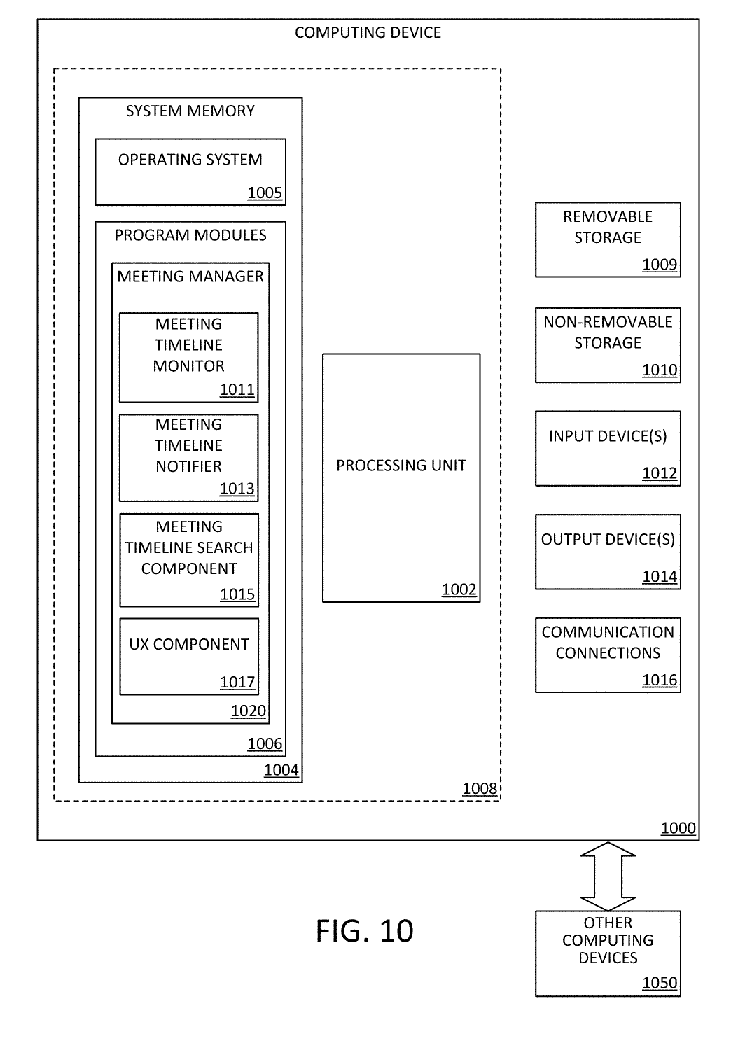

FIGS. 10-13 and the associated descriptions provide a discussion of a variety of operating environments in which aspects of the disclosure may be practiced. However, the devices and systems illustrated and discussed with respect to FIGS. 10-13 are for purposes of example and illustration and are not limiting of a vast number of computing device configurations that may be utilized for practicing aspects of the disclosure, as described herein.

FIG. 10 is a block diagram illustrating physical components (e.g., hardware) of a computing device 1000 with which aspects of the disclosure may be practiced. The computing device components described below may have computer executable instructions for implementing a meeting manager 1020 on a computing device (e.g., server computing device and/or client computing device), including computer executable instructions for meeting manager 1020 that can be executed to implement the methods disclosed herein, including a method of receiving a request to schedule a meeting and creating a meeting comprising partitioning the meeting timeline into at least one subset of time associated with at least one meeting subject. In a basic configuration, the computing device 1000 may include at least one processing unit 1002 and a system memory 1004. Depending on the configuration and type of computing device, the system memory 1004 may comprise, but is not limited to, volatile storage (e.g., random access memory), non-volatile storage (e.g., read-only memory), flash memory, or any combination of such memories. The system memory 1004 may include an operating system 1005 and one or more program modules 1006 suitable for running meeting manager 1020, and, in particular, a Meeting Timeline Monitor 1011, a Meeting Timeline Notifier 1013, a Meeting Timeline Search Component 1015, and/or UX Component 1017.

The operating system 1005, for example, may be suitable for controlling the operation of the computing device 1000. Furthermore, embodiments of the disclosure may be practiced in conjunction with a graphics library, other operating systems, or any other application program and is not limited to any particular application or system. This basic configuration is illustrated in FIG. 10 by those components within a dashed line 1008. The computing device 1000 may have additional features or functionality. For example, the computing device 1000 may also include additional data storage devices (removable and/or non-removable) such as, for example, magnetic disks, optical disks, or tape. Such additional storage is illustrated in FIG. 10 by a removable storage device 1009 and a non-removable storage device 1010.

As stated above, a number of program modules and data files may be stored in the system memory 1004. While executing on the processing unit 1002, the program modules 1006 (e.g., meeting manager 1020) may perform processes including, but not limited to, the aspects, as described herein. Other program modules that may be used in accordance with aspects of the present disclosure, and in particular for receiving a request to schedule a meeting and creating a meeting comprising partitioning the meeting timeline into at least one subset of time associated with at least one meeting subject, may include Meeting Timeline Monitor 1011, Meeting Timeline Notifier 1013, Meeting Timeline Search Component 1015, and/or UX Component 1017, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 10 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 1000 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 1000 may also have one or more input device(s) 1012 such as a keyboard, a mouse, a pen, a sound or voice input device, a touch or swipe input device, etc. The output device(s) 1014 such as a display, speakers, a printer, etc. may also be included. The aforementioned devices are examples and others may be used. The computing device 1000 may include one or more communication connections 1016 allowing communications with other computing devices 1050. Examples of suitable communication connections 1016 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1004, the removable storage device 1009, and the non-removable storage device 1010 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1000. Any such computer storage media may be part of the computing device 1000. Computer storage media may be non-transitory media that does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

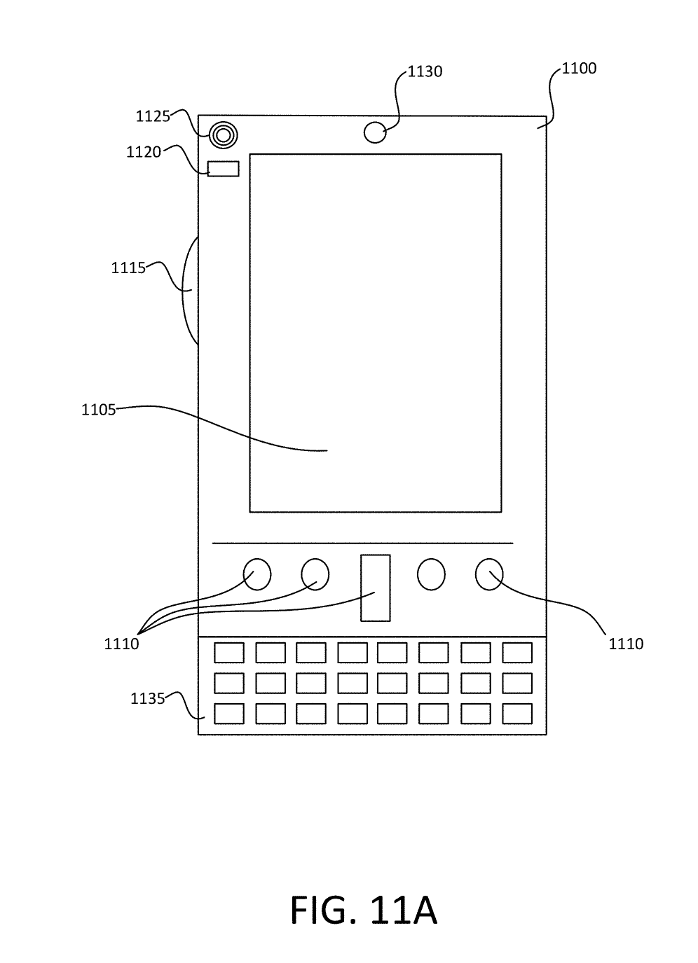

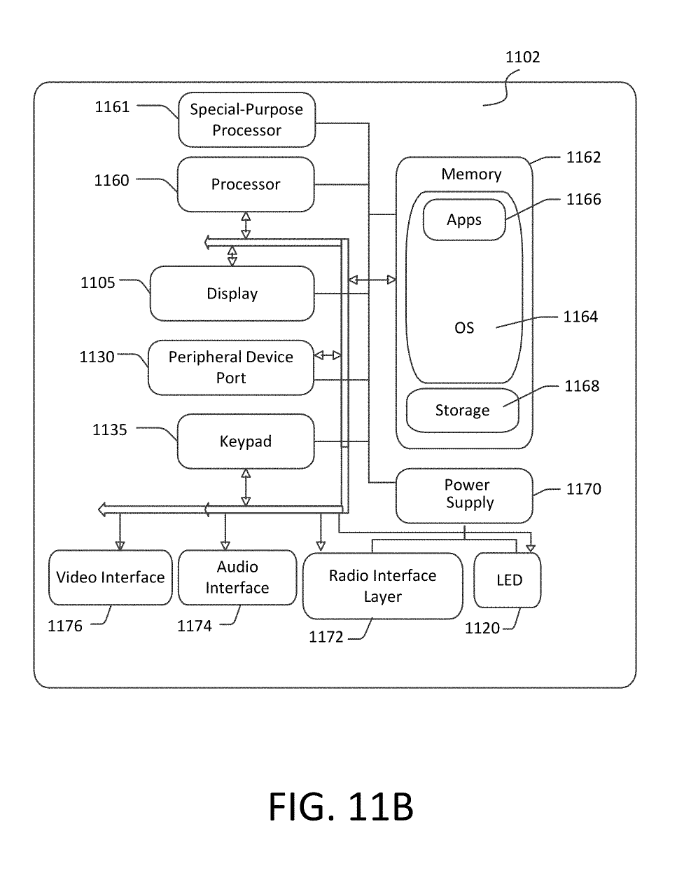

FIGS. 11A and 11B illustrate a mobile computing device 1100, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 11A, one aspect of a mobile computing device 1100 for implementing the aspects is illustrated. In a basic configuration, the mobile computing device 1100 is a handheld computer having both input elements and output elements. The mobile computing device 1100 typically includes a display 1105 and one or more input buttons 1110 that allow the user to enter information into the mobile computing device 1100. The display 1105 of the mobile computing device 1100 may also function as an input device (e.g., a touch screen display). If included, an optional side input element 1115 allows further user input. The side input element 1115 may be a rotary switch, a button, or any other type of manual input element. In alternative aspects, mobile computing device 1100 may incorporate more or less input elements. For example, the display 1105 may not be a touch screen in some embodiments. In yet another alternative embodiment, the mobile computing device 1100 is a portable phone system, such as a cellular phone. The mobile computing device 1100 may also include an optional keypad 1135. Optional keypad 1135 may be a physical keypad or a “soft” keypad generated on the touch screen display. In various embodiments, the output elements include the display 1105 for showing a graphical user interface (GUI), a visual indicator 1120 (e.g., a light emitting diode), and/or an audio transducer 1125 (e.g., a speaker). In some aspects, the mobile computing device 1100 incorporates a vibration transducer for providing the user with tactile feedback. In yet another aspect, the mobile computing device 1100 incorporates input and/or output ports, such as an audio input (e.g., a microphone jack), an audio output (e.g., a headphone jack), and a video output (e.g., a HDMI port) for sending signals to or receiving signals from an external device.

FIG. 11B is a block diagram illustrating the architecture of one aspect of a mobile computing device. That is, the mobile computing device 1100 can incorporate a system (e.g., an architecture) 1102 to implement some aspects. In one embodiment, the system 1102 is implemented as a “smart phone” capable of running one or more applications (e.g., browser, e-mail, calendaring, contact managers, messaging clients, games, and media clients/players). In some aspects, the system 1102 is integrated as a computing device, such as an integrated personal digital assistant (PDA) and wireless phone.

One or more application programs 1166 may be loaded into the memory 1162 and run on or in association with the operating system 1164. Examples of the application programs include phone dialer programs, e-mail programs, personal information management (PIM) programs, word processing programs, spreadsheet programs, Internet browser programs, messaging programs, and so forth. The system 1102 also includes a non-volatile storage area 1168 within the memory 1162. The non-volatile storage area 1168 may be used to store persistent information that should not be lost if the system 1102 is powered down. The application programs 1166 may use and store information in the non-volatile storage area 1168, such as email or other messages used by an email application, and the like. A synchronization application (not shown) also resides on the system 1102 and is programmed to interact with a corresponding synchronization application resident on a host computer to keep the information stored in the non-volatile storage area 1168 synchronized with corresponding information stored at the host computer. As should be appreciated, other applications may be loaded into the memory 1162 and run on the mobile computing device 1100, including the instructions for receiving a request to schedule a meeting and creating a meeting comprising partitioning the meeting timeline into at least one subset of time associated with at least one meeting subject as described herein (e.g., meeting manager, Meeting Timeline Monitor, Meeting Timeline Notifier, Meeting Timeline Search Component, and/or UX component, etc.).

The system 1102 has a power supply 1170, which may be implemented as one or more batteries. The power supply 1170 may further include an external power source, such as an AC adapter or a powered docking cradle that supplements or recharges the batteries. The system 1102 may also include a radio interface layer 1172 that performs the function of transmitting and receiving radio frequency communications. The radio interface layer 1172 facilitates wireless connectivity between the system 1102 and the “outside world,” via a communications carrier or service provider. Transmissions to and from the radio interface layer 1172 are conducted under control of the operating system 1164. In other words, communications received by the radio interface layer 1172 may be disseminated to the application programs 1166 via the operating system 1164, and vice versa.

The visual indicator 1120 may be used to provide visual notifications, and/or an audio interface 1174 may be used for producing audible notifications via an audio transducer 1125 (e.g., audio transducer 1125 illustrated in FIG. 11A). In the illustrated embodiment, the visual indicator 1120 is a light emitting diode (LED) and the audio transducer 1125 may be a speaker. These devices may be directly coupled to the power supply 1170 so that when activated, they remain on for a duration dictated by the notification mechanism even though the processor 1160 and other components might shut down for conserving battery power. The LED may be programmed to remain on indefinitely until the user takes action to indicate the powered-on status of the device. The audio interface 1174 is used to provide audible signals to and receive audible signals from the user. For example, in addition to being coupled to the audio transducer 1125, the audio interface 1174 may also be coupled to a microphone to receive audible input, such as to facilitate a telephone conversation. In accordance with embodiments of the present disclosure, the microphone may also serve as an audio sensor to facilitate control of notifications, as will be described below. The system 1102 may further include a video interface 1176 that enables an operation of peripheral device 1130 (e.g., on-board camera) to record still images, video stream, and the like.

A mobile computing device 1100 implementing the system 1102 may have additional features or functionality. For example, the mobile computing device 1100 may also include additional data storage devices (removable and/or non-removable) such as, magnetic disks, optical disks, or tape. Such additional storage is illustrated in FIG. 11B by the non-volatile storage area 1168.

Data/information generated or captured by the mobile computing device 1100 and stored via the system 1102 may be stored locally on the mobile computing device 1100, as described above, or the data may be stored on any number of storage media that may be accessed by the device via the radio interface layer 1172 or via a wired connection between the mobile computing device 1100 and a separate computing device associated with the mobile computing device 1100, for example, a server computer in a distributed computing network, such as the Internet. As should be appreciated such data/information may be accessed via the mobile computing device 1100 via the radio interface layer 1172 or via a distributed computing network. Similarly, such data/information may be readily transferred between computing devices for storage and use according to well-known data/information transfer and storage means, including electronic mail and collaborative data/information sharing systems.

As should be appreciated, FIGS. 11A and 11B are described for purposes of illustrating the present methods and systems and are not intended to limit the disclosure to a particular sequence of steps or a particular combination of hardware or software components.

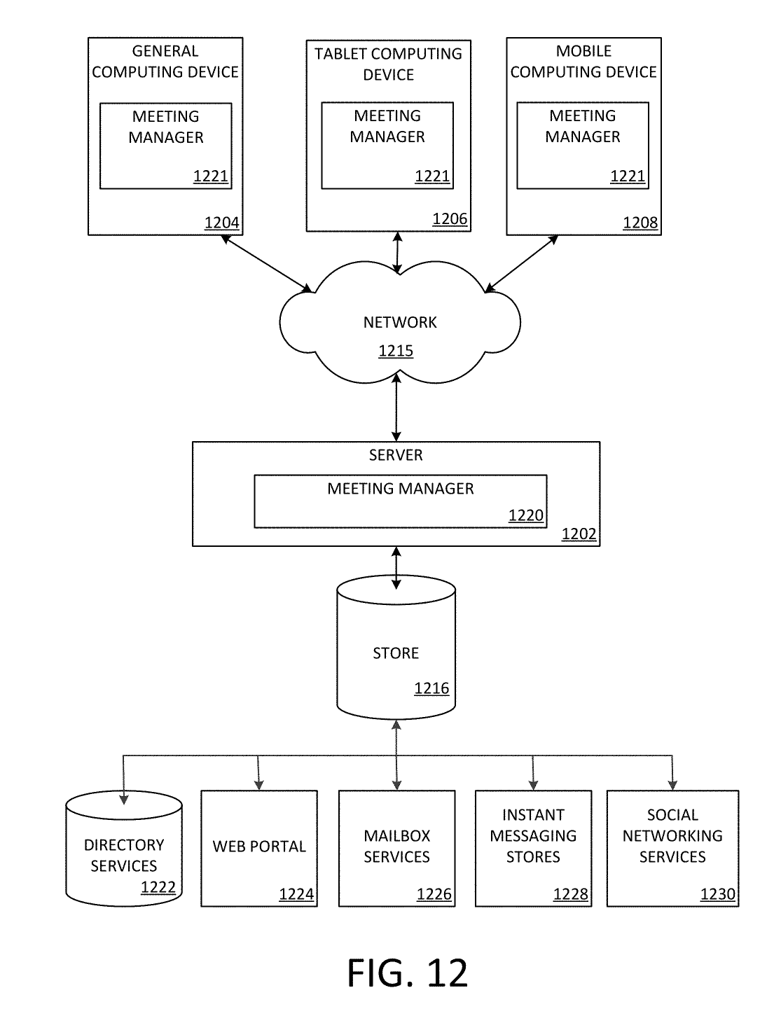

FIG. 12 illustrates one aspect of the architecture of a system for processing data received at a computing system from a remote source, such as a general computing device 1204 (e.g., personal computer), tablet computing device 1206, or mobile computing device 1208, as described above. Content displayed at server device 1202 may be stored in different communication channels or other storage types. For example, various documents may be stored using a directory service 1222, a web portal 1224, a mailbox service 1226, an instant messaging store 1228, or a social networking service 1230. The meeting manager 1221 may be employed by a client that communicates with server device 1202, and/or the meeting manager 1220 may be employed by server device 1202. The server device 1202 may provide data to and from a client computing device such as a general computing device 1204, a tablet computing device 1206 and/or a mobile computing device 1208 (e.g., a smart phone) through a network 1215. By way of example, the computer system described above with respect to FIGS. 1-11 may be embodied in a general computing device 1204 (e.g., personal computer), a tablet computing device 1206 and/or a mobile computing device 1208 (e.g., a smart phone). Any of these embodiments of the computing devices may obtain content from the store 1216, in addition to receiving graphical data useable to either be pre-processed at a graphic-originating system or post-processed at a receiving computing system.

As should be appreciated, FIG. 12 is described for purposes of illustrating the present methods and systems and is not intended to limit the disclosure to a particular sequence of steps or a particular combination of hardware or software components.

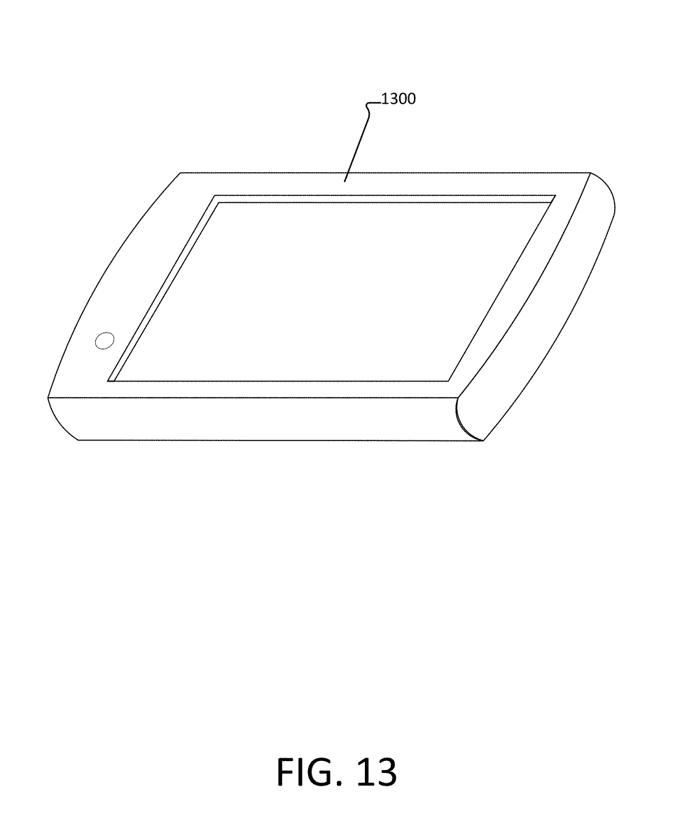

FIG. 13 illustrates an exemplary tablet computing device 1300 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As should be appreciated, FIG. 13 is described for purposes of illustrating the present methods and systems and is not intended to limit the disclosure to a particular sequence of steps or a particular combination of hardware or software components.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A computer system comprising:
at least one processing unit; and
at least one memory storing computer executable instructions that, when executed by the at least one processing unit, cause the computer system to:
receive a request to schedule a meeting, wherein the meeting is associated with a meeting duration;
based at least in part on the meeting duration, create a meeting timeline;
partition the meeting timeline into at least two time periods, wherein each time period corresponds to a portion of the meeting duration; and
associate at least one media item with at least one of the at least two time periods of the meeting timeline.

2. The computer system of claim 1, the computer executable instructions further causing the computer system to:
during the meeting, send a notification to at least one meeting participant when at least one of the at least two time periods has expired.

3. The computer system of claim 1, wherein at least one of the at least two time periods comprises a start time and an end time.

4. The computer system of claim 3, the computer executable instructions further causing the computer system to:
in response to a change to the meeting, adjust at least one of the start time and the end time.

5. The computer system of claim 4, wherein adjusting at least one of the start time and the end time is automatic.

6. The computer system of claim 4, wherein adjusting at least one of the start time and the end time is initiated by a meeting participant.

7. The computer system of claim 1, wherein the media item is one of a document, a presentation, a spreadsheet, an image, a video file, an audio file, an executable file, a compressed file, and a hyperlink.

8. The computer system of claim 1, wherein the media item is identified on the meeting timeline by an icon.

9. The computer system of claim 8, wherein the media item is accessible by activating the icon.

10. The computer system of claim 1, the computer executable instructions further causing the computer system to:
send a notification to at least one meeting participant, wherein the notification includes the at least one media item.

11. The computer system of claim 10, wherein the notification is sent when a first time period of the meeting timeline expires, and wherein the at least one media item is associated with a second time period of the meeting timeline.

12. The computer system of claim 1, wherein each of the at least two time periods is associated with one of a meeting topic and a meeting participant.

13. A method of creating a meeting timeline, comprising:
receiving a request to schedule a meeting, wherein the meeting is associated with a meeting duration;
based at least in part on the meeting duration, creating a meeting timeline;
receiving at least two topics for discussion at the meeting;
automatically partitioning the meeting timeline into at least two time periods corresponding to the at least two topics, wherein each time period corresponds to a portion of the meeting duration;
receiving an adjustment to at least a first time period of the at least two time periods; and
automatically adjusting at least a second time period of the at least two time periods such that the at least two time periods correspond to the meeting duration.

14. The method of claim 13, further comprising:
receiving at least one meeting participant, wherein the at least one meeting participant is assigned to speak during at least one of the at least two time periods.

15. The method of claim 13, the computer executable instructions further causing the computer system to:
during the meeting, send a notification to at least one meeting participant when at least one of the at least two time periods has expired.

16. The method of claim 13, wherein at least one of the at least two time periods comprises a start time and an end time.

17. The method of claim 13, further comprising:
collecting data associated with the meeting; and
prioritizing one or more aspects of the meeting.

18. The method of claim 13, wherein the one or more aspects comprise at least one of:
a time period, a media item, a full recording of a meeting, a partial recording of a meeting and a meeting topic.

19. The method of claim 13, further comprising:
associating at least one media item with at least one of the two or more time periods.

20. A computer storage device storing computer-executable instructions that when executed by a processor perform a method, comprising:
receiving a request to schedule a meeting, wherein the meeting is associated with a meeting duration;
based at least in part on the meeting duration, creating a meeting timeline;
partitioning the meeting timeline into at least two time periods, wherein each time period corresponds to a portion of the meeting duration;
associating at least one media item with at least one of the at least two time periods of the meeting timeline; and
prioritizing one or more aspects of the meeting.
